(19) United States
(12) Patent Application Publication
(10) Pub. No.: US 2008/0173243 A1
(43) Pub. Date: Jul. 24, 2008

(54) METHOD AND APPARATUS FOR CARRYING OUT AT LEAST ONE PROCEDURE ON AN ANIMAL, IN PARTICULAR FOR MILKING AN ANIMAL

(76) Inventors: Herbert Dreyer, Ahlerstedt (DE); Michael Nahues, Warendorf (DE); Manfred Aigner, Hebertsfelden (DE)

Correspondence Address: SMITH MOORE LLP, P.O. BOX 21927, GREENSBORO, NC, 27420, US

(21) Appl. No.: 11/625,506

(22) Filed: Jan. 22, 2007

(51) Int. Cl. A01K 1/12

(52) U.S. Cl. 119/14.02; 119/14.08

(57) ABSTRACT

In order to carry out at least one procedure on an animal, in particular for milking an animal, a method and an apparatus, in which animals are successively led to a facility, are proposed. The animals are transferred to an exit region of the facility and stay there until a subsequent animal enters the vicinity of the exit region. The exit region is then opened and the subsequent animal can enter the exit region.

The subject matter of the invention relates to a method and an apparatus for carrying out at least one procedure on an animal, in particular for milking an animal.

Although the invention is described below with regard to use in carousel milking facilities, use is not restricted to carousels. If the text below refers to “milking carousels”, it is not restricted thereby to rotating facilities. In the sense of this application, the term “milking carousel” also includes those facilities which have, for example, a base in the form of an endless belt.

The invention can be used not only to milk cows but is also suitable for use with other lactating animals and is also suitable, in particular, for milking sheep, goats, mares, donkeys, buffalo, dromedaries, llamas, camels, yaks and the like.

Milking carousel facilities, as described, for example, in DE-A1-26 50 741, are known for the purpose of milking cows. The carousel milking facility has a movable base on which a plurality of milking stalls are arranged. The base is in the form of a platform. The latter is arranged such that it can be rotated about a vertical axis.

In addition, DE-A1-41 01 530, for example, discloses a milking carousel having a disk-shaped platform for cows which is driven in rotation. The platform is subdivided into individual milking stalls which are arranged on their own mobile segments whose running rollers are supported on stationary circular running rails. The drive for the circular movement of the individual segments is effected using a drive motor which is directly arranged on one of the segments. The drive motor is formed by one or more hydraulic motors and a hydraulic pump which is driven by an electric motor. During operation, the electric motor is controlled using control signals, with the result that the hydraulic pump supplies the hydraulic motors with hydraulic oil. During normal operation, the milking carousel moves continuously, the cows being milked during one revolution. It is also possible for a cow to remain in the milking stall for a further revolution.

If an animal has been fully milked, it leaves the milking carousel via an exit region. The problem with this is that the animals may become agitated in the region of the exit region. The animals also tend to leave the milking carousel prematurely, in particular when a leader leaves the milking carousel.

On the basis of this, the present invention is based on the objective of specifying a method which improves the carrying-out of at least one procedure on an animal and improves animal safety.

According to the invention, this object is achieved by means of a method having the features of claim 1. The dependent patent claims relate to advantageous developments and refinements of the method.

The method for carrying out at least one procedure on an animal, in particular for milking an animal, is distinguished by the fact that the animals are successively led to a facility, in particular a milking carousel. The animals can be led in an active or passive manner. The animals are milked as the milking carousel revolves. The animals are successively transferred to an exit region from the individual milking stalls of the milking carousel. It has proven to be advantageous for an animal to stay in the exit region until a subsequent animal enters the vicinity of the exit region. The exit region is only then opened for the animal in the exit region.

Conducting the method in this manner according to the invention results in the subsequent animals remaining calmly in the facility. In particular, on account of the movement possibilities which the animals have in a carousel milking facility, for example, the animals are prevented from attempting to climb over the milking stall frameworks.

As a result of the fact that an animal preferably remains in the exit region for a few seconds, the subsequent animals which are in the facility, in particular on a carousel milking platform, have the longest possible visual contact with the animal in the exit region and thus remain calm.

One advantageous refinement of the method proposes determining whether or not the exit region is occupied. Coordinated carrying-out of the method can thus be improved even further.

A check is preferably carried out in order to determine whether an animal has left the exit region, thus reducing the risk of collision with subsequent animals.

Yet another advantageous refinement of the method proposes that the exit region has a blocking apparatus which is actuated on the basis of the position of a subsequent animal. In particular, it is proposed that occupancy of the exit region is determined using at least one sensor which generates a signal for the controller of the blocking apparatus.

If at least one sensor is used to determine whether a subsequent animal has reached a predetermined position, the blocking apparatus is opened only when the sensor has been used to determine that the subsequent animal is in the predetermined position. In this respect, premature opening of the exit region is avoided.

Yet another advantageous refinement of the method proposes that the blocking apparatus closes the exit region when a sensor generates a signal indicating that the animal has vacated the exit region.

The procedure carried out on the animal can be a milking operation, a disinfecting operation, a cleaning operation, an inspection operation or some other operation. In particular, it is proposed that the beginning of the procedure in the exit region is determined on the basis of the position of the subsequent animal. This makes it possible for the animal in the exit region to adopt a “position of rest” before the procedure is carried out.

The method according to the invention is also distinguished by the fact that the position of at least one body part, in particular a rump, of an animal in the exit region is determined. Such determination of the position of the body part, in particular of the rump, of the animal in the exit region has the advantage that, in the case of procedures, in particular in the case of automatic or semiautomatic procedures, in the region of the teats and of the udder, a predefined starting position can be determined for the apparatuses for carrying out the procedure.

Herds, in particular large herds, do not necessarily comprise animals having an essentially equal length. It is therefore proposed that the length of the exit region can be adjusted, thus enabling adaptation to the animals. The ability to adjust the length of the exit region is preferably achieved by virtue of the blocking apparatus being able to be moved in the longitudinal direction of the exit region.

The length of the exit region is preferably set on an animal-individual basis. Data which are provided by a herd management system can be used for this purpose. It is also possible for animals to be identified in the exit region, so that the data can also be verified.

Yet another advantageous refinement of the method proposes that the procedure in the exit region comprises at least one disinfecting step. At least one nozzle is provided for the purpose of applying the disinfectant to the teats of the animal. In this case, particular preference is given to a method in which the nozzle can be moved in the longitudinal direction of the exit region, so that, on the one hand, it is possible to adjust the position of the nozzle with respect to the animal and, on the other hand, a larger region can be sprayed.

Yet another advantageous refinement of the method proposes that the facility comprises at least one platform which can be moved relative to the exit region and has a plurality of milking stalls, and the animals are milked in the milking stalls. One refinement in which the platform can be rotated is particularly preferred in this case.

Yet another inventive concept proposes an apparatus for carrying out at least one procedure on an animal, in particular for milking an animal. The apparatus comprises at least one milking stall and an exit region, the exit region having a blocking apparatus which opens the exit region when a subsequent animal enters the vicinity of the exit region.

In this case, particular preference is given to one refinement of the apparatus in which provision is made of at least one sensor which provides a controller of the blocking apparatus with a signal on the basis of the occupancy of the exit region.

At least one sensor is used to determine whether a subsequent animal has reached a predetermined position, and the blocking apparatus opens only when the sensor has been used to determine that the subsequent animal is in the predetermined position.

Yet another advantageous refinement of the apparatus proposes providing at least one sensor for detecting the position of at least one body part, in particular a rump, of an animal in the exit region.

The apparatus is also distinguished by the fact that the length of the exit region can be adjusted. To this end, the blocking apparatus is advantageously designed such that it can be moved in the longitudinal direction of the exit region.

Yet another advantageous refinement of the apparatus proposes providing a controller which has a data memory containing animal-individual data, the length of the exit region being adjusted on an animal-individual basis.

Yet another advantageous refinement of the apparatus proposes providing at least one disinfecting device in the exit region. The disinfecting device comprises at least one nozzle which can preferably be moved in the longitudinal direction of the exit region.

The apparatus is also distinguished by the fact that it comprises at least one platform which can be moved relative to the exit region and has a plurality of milking stalls. The platform can preferably be rotated.

The method according to the invention and the apparatus according to the invention have numerous advantages; in particular, controlled leaving of a milking carousel is preferably achieved. An operator can examine the health of the udder, can examine the animal for injury or the like in the exit region since the animal stays in the exit region for a particular period of time.

If a disinfecting operation is carried out in the exit region, the spraying pulse can be shorter for a stationary cow than for a moving cow. This results in reduced consumption of disinfectant, which is likewise associated with economic advantages.

The method according to the invention and the apparatus according to the invention also have the advantage that the milking performance of the facility and of the milker is enhanced by virtue of the animals remaining on the carousel platform for a relatively long period of time. In addition, a greater amount of calm is introduced into the operation. The cows do not tear off the milking equipment two or three milking stalls before exiting the carousel. In addition, the milking processes are not disrupted by agitated animals before they exit the carousel. Various work in the milking area can move the carousel exit region, for example the checking of udder health, udder disinfection, the examination of the cow for visible injury, diseases, and the selection of the animals.

Further details and advantages of the invention are explained with reference to the exemplary embodiments which are illustrated in the drawing without restricting the subject matter of the invention to these specific exemplary embodiments.

In the drawing:

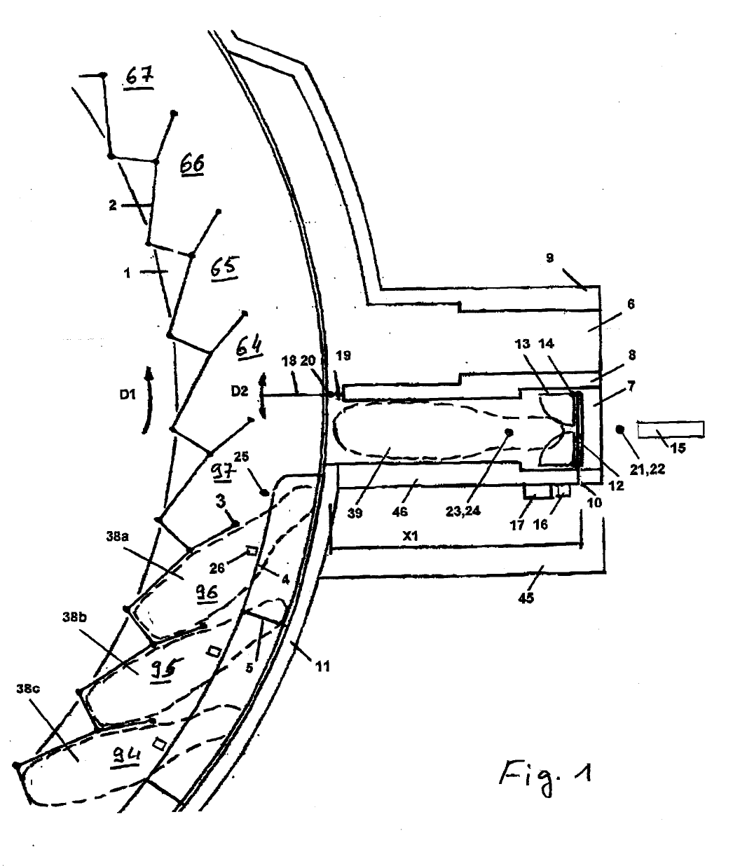

FIG. 1: diagrammatically shows a plan view of an entry region and an exit region of a milking carousel,

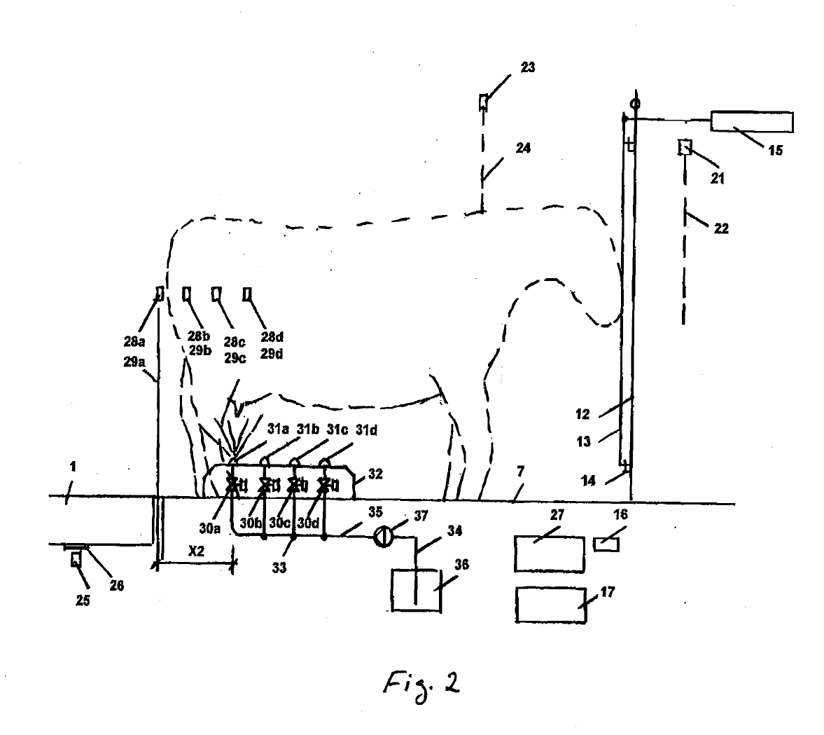

FIG. 2: diagrammatically shows a side view of one exemplary embodiment of the design of the exit region,

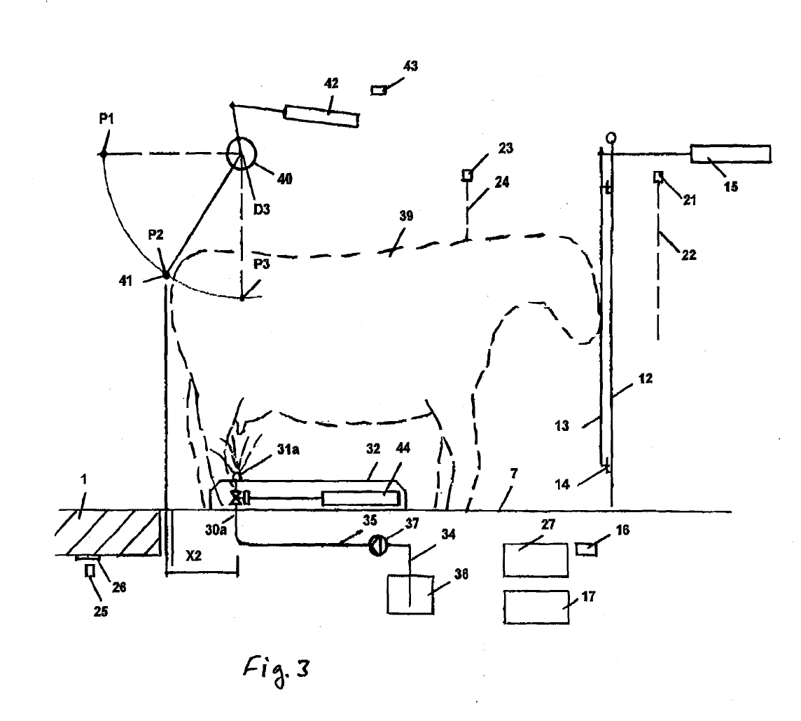

FIG. 3: diagrammatically shows a side view of a second exemplary embodiment of an exit region of a milking carousel,

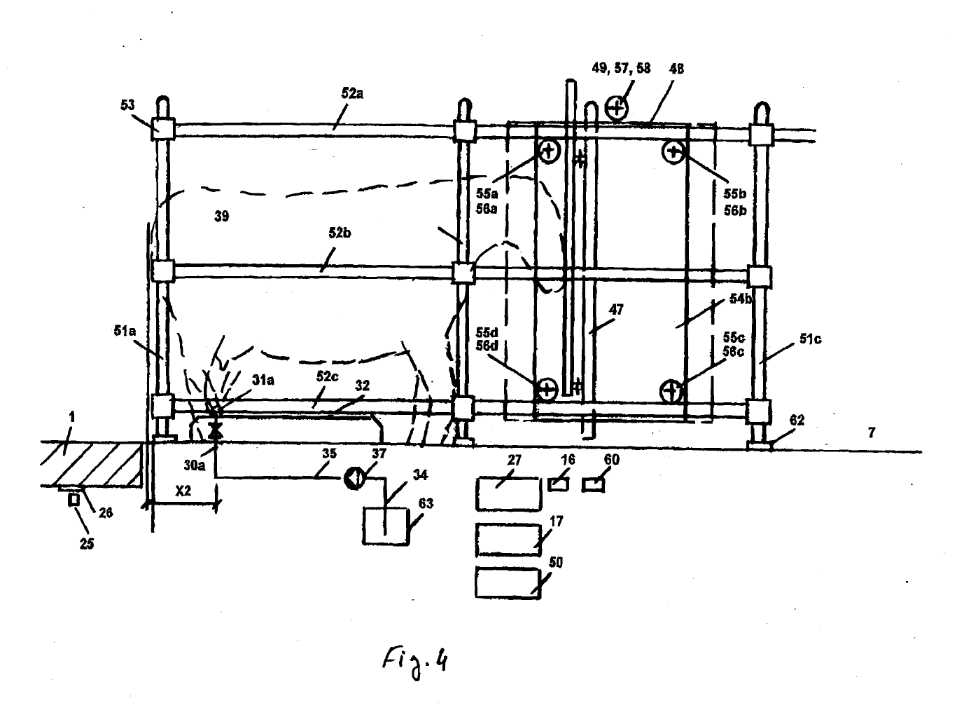

FIG. 4: diagrammatically shows a side view of a third exemplary embodiment of an exit region of a milking carousel, and

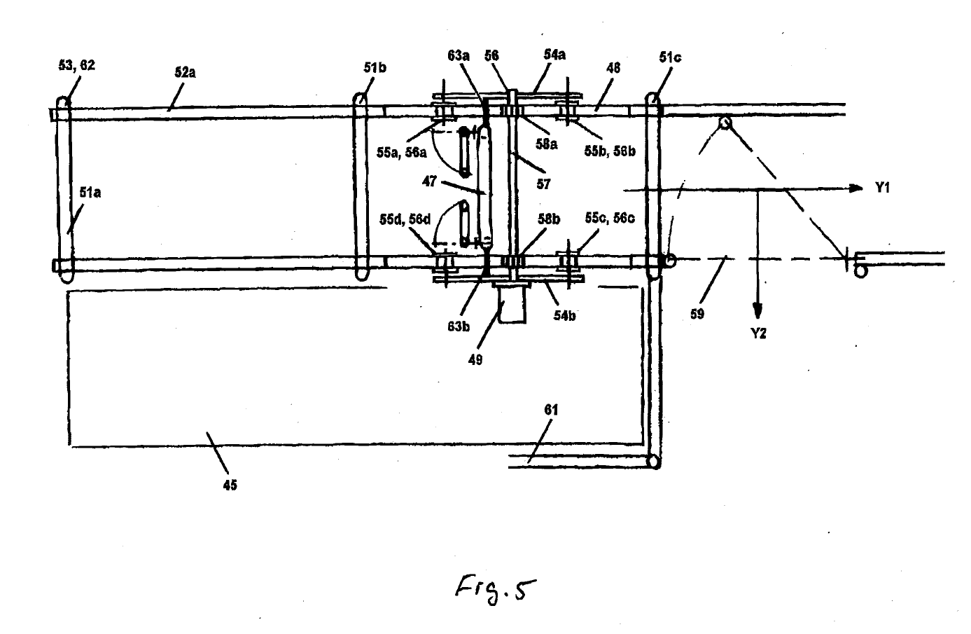

FIG. 5: diagrammatically shows a plan view of an exit region of a milking carousel having a work pit for an operator.

FIG. 1 diagrammatically illustrates a plan view of one embodiment of a milking carousel having an entry region and an exit region. The milking carousel comprises a carousel platform 1 on which a plurality of milking stalls 64, 65, 66, 67 . . . 94, 95, 96, 97 are arranged. The individual milking stalls are bounded by appropriate frameworks 2 which are fastened to the carousel platform 1. Each milking stall has a separating element 3 which runs in an essentially horizontal manner and is essentially tubular. A shoulder of an animal, which is in the milking stall, can butt against the separating element 3. If the carousel platform is rotated in the arrow direction D1, a left shoulder of an animal can rest against the separating element 3, as can be seen in FIG. 1.

The animals are restricted toward the outside by a breast rail 4. The breast rail 4 is connected to a carousel outer wall 11 by means of a holder 5. The breast rail 4 and the frameworks 2 of the milking stalls as well as the separating elements 3 restrict the animals for a milking operation on the carousel platform 1.

In the exemplary embodiment illustrated, the arrangement of the milking stalls is selected in such a manner that the carousel milking facility is a herringbone carousel milking facility. This is not absolutely necessary. Other designs of the carousel milking facility are possible.

An entry region 6 is provided for the purpose of entering the carousel platform 1. An exit region 7 through which the animals can leave the carousel platform 1 is provided essentially parallel to the entry region 6. The entry region 6 and the exit region 7 are separated from one another by means of a separating wall 8. The separating wall 8 may also be a framework. The entry region 6 is also bounded by a side wall 9 and the exit region is bounded by a side wall 10.

An element 18 which can be pivoted about an axis 19 is arranged on the separating wall 8. The pivoting direction of the element 18 is indicated by the arrow D2. In the exemplary embodiment illustrated, the element 18 essentially extends radially inward from the separating wall 8. A safety switch 20 is provided next to the element 18. The element 18 and the safety switch 20 form a safety apparatus which ensures that animals cannot be injured, either when entering or when leaving the carousel platform 1, as a result of being squashed between rotatable and stationary parts of the milking carousel.

The exit region 7 is preferably selected in such a manner that the length of the exit region 7 essentially corresponds to the length of an animal, as can be seen in FIG. 1.

The exit region 7 has a blocking apparatus 12 which is arranged at the more remote end of the exit region 7, as seen from the milking platform 1. The blocking apparatus is formed by door leaves 13 which can be pivoted about the axis 14. In the exemplary embodiment illustrated, two door leaves 13 are provided. This is not absolutely necessary. It is also possible to provide one leaf which blocks the exit region 7. In the exemplary embodiment illustrated, the axis 14 runs vertically. This is not necessary. It is also possible to provide a leaf which can be pivoted about an essentially horizontal axis. In addition, the exit region 7 can be blocked using a blocking element which can be moved back and forth in a vertical direction.

The exit region 7 has at least one sensor 23. The sensor 23 is used to determine whether an animal is in the exit region 7. The sensor 23 is preferably an optical sensor. This is not absolutely necessary. It is also possible for the sensor 23 to be a mechanical sensor or a sensor which reacts to an identification means of the animal.

The blocking apparatus 12 is activated, that is to say the exit region 7 is opened, only when the sensor 23 is used to determine that an animal is in the carousel exit region 7.

If there is no animal in the exit region 7, the blocking apparatus 12 is closed. The length of the exit region 7 and the arrangement of the at least one sensor 23 are selected in such a manner that it is always ensured that the presence of an animal in the exit region 7 is ensured.

An actuating unit 15 which is connected to a controller 17 is provided for the purpose of actuating the blocking apparatus. The actuating unit 15 may be pneumatic and/or electromotive. If the actuating unit 15 is a pneumatic actuating unit, a changeover valve 16 which is connected to corresponding actuating elements for the door leaves 13 is provided. A sensor 21 is used to determine whether the exit region 7 is open or closed. The sensor 21 can be a mechanical sensor. It is also possible for the sensor 21 to be an electrical, magnetic or optical sensor. A plurality of sensors 21 may also be provided. The beam path of an optical sensor 21 is denoted 22.

A sensor unit 25 is arranged in a stationary manner in front of the exit region 7 in the direction of rotation D1 of the platform 1. Each milking stall has a pushbutton 26 which interacts with the sensor unit 25.

Animals successively enter the carousel platform 1 via the entry region 6. The animals are at least milked during the travel of the carousel platform 1. If the milking stall 97, for example, has reached the exit region, the animal leaves the milking stall and the animal 39 enters the exit region 7. The blocking apparatus 12 is closed, with the result that the animal 39 remains in the exit region. The carousel platform 1 continues to move. The pushbutton 26 enters into an operative connection with the sensor unit 25. The sensor unit 25 provides the controller 17 with a signal. The controller 17 generates, for example, an activation signal in order to release a changeover valve 16 for the door leaves 13. The blocking apparatus 12 is opened using the actuating element 15.

The blocking apparatus 12 is closed as soon as the sensor 21 has determined that the animal is outside the range of the sensor 21. This is the case, in particular, when the animal 39 has completely left the exit region.

The sensor unit 25 and the pushbutton 26, which interacts with the sensor unit 25, are arranged in such a manner that the animal 38a which is in the milking stall 96 retains relatively prolonged visual contact with the animal 39 in the exit region 7, and the exit region 7 is opened only at a relatively late point in time. As a result, the animal 38a in the milking stall 96 remains calm. This also applies to the animals 38b, c in the milking stalls 95 and 94.

Conducting the method in this manner reduces the risk of animals being injured as a result of agitation in the milking stalls.

A work pit 45 is provided for an operator in the base beside the side wall 10 of the exit region 7 in order to examine the animals in the exit region 7 for diseases, injury etc. and in order to carry out treatments on the animal, for example teat dipping, and for other activities, for example actuating a sorting apparatus etc. The side wall has a corresponding operating opening 46.

FIG. 2 diagrammatically shows a carousel exit region in section. The illustration shown in FIG. 2 reveals that the sensor unit 25 and the pushbuttons 26 are arranged underneath the carousel milking platform 1. This is not absolutely necessary. It is also possible for the sensor unit 25 and the pushbuttons 26 to be arranged above the milking platform. In particular, the pushbuttons 26 may be arranged on the frameworks and/or the separating element 3. In the exemplary embodiment illustrated in FIG. 2, the sensors 21, 23 are optical sensors. The beams are indicated with dashed lines in FIG. 2 using the reference symbols 22 and 24.

The milking facility has spray nozzles 31a to 31d for the purpose of disinfecting the teats of an animal. The spray nozzles 31a to 31d are connected to a storage container 36 by means of the lines 34, 35. A delivery device 37 is provided for the purpose of delivering a disinfectant from the storage container 36 to the spray nozzles 31a to 31d.

Valves 30a to 30d which are preferably solenoid valves are arranged in each feed line to the spray nozzles 31a to 31d.

Sensors 28a to 28d are provided for the purpose of determining the position of the rear part of the animal. In the exemplary embodiment illustrated, four sensors 28a to 28d are provided. A reflected beam 29a belongs to the sensor 28a.

The determination of the end region of an animal can be improved using a plurality of sensors.

The arrangement of the sensors and of the spray nozzles essentially depends on the length of the body of the animals in the concern in which the milking facility is provided.

The teats of an animal are automatically disinfected by the sensor 23 first of all being used to determine whether an animal is in the exit region 7. The sensor 23 provides a controller 27 with a signal, said controller being used to control udder disinfection.

The sensors 28a to 28d are used to determine the rump of the animal irrespective of whether or not the head of an animal is at the blocking apparatus. If the sensors 28a to 28d were optical sensors, the information that the rump is in the region between the sensor 28a and the sensor 28b would be derived from the illustration shown in FIG. 2.

If the pushbutton 26 which is firmly connected to the carousel platform 1 enters into the range of the sensor 25, the latter sends a signal to the electrical controller 27 and, preferably with a time delay, to the controller 17 of the blocking apparatus 12.

If the sensor 23 has been used to determine that an animal is already in the exit region 7, the controller 27 is used to send an activation signal to the delivery device 37 for supplying a disinfectant to the nozzles 31a to 31d. The solenoid valve 30a is opened and the disinfectant passes, via the spray nozzle 31a, to the teats of the animal in the carousel exit region.

The amount of disinfectant which is sprayed onto the teats of the animal can be adjusted. This also applies to the duration of the disinfecting operation.

The sensors 28a to 28d are assigned to the individual valves, preferably solenoid valves 30a to 30d. Depending on which sensor is active or passive, the corresponding valves are also driven.

After the teats of the animal have been disinfected, the controller 17 generates an activation signal for actuating the blocking apparatus 12. The blocking apparatus 12 opens the exit region 7 and the animal can leave the exit region 7.

In concerns in which the length of the animals in the herds is within small tolerances, the facility can be simplified to the effect that only one spray nozzle is provided and is accordingly arranged in such a manner that the teats of the animal are disinfected.

After the animal has left the exit region, the exit region 7 is occupied by a subsequent animal. This takes place until all of the animals which have to be disinfected have been subjected to a disinfecting operation.

FIG. 3 illustrates another exemplary embodiment of an apparatus. The fundamental design of the milking carousel and of the exit region corresponds to the design of the exemplary embodiment illustrated in FIGS. 1 and 2.

A sensor 41 which can be pivoted about an essentially horizontal axis is provided in FIG. 3 for the purpose of determining the position of the rump of an animal. The sensor 41 can be brought into abutment against the rump of the animal, for example in the form of a clip. The deflection of the sensor 41 is determined using a rotary encoder 40, for example. P1 is used to denote a sensor position in which the animal can enter the exit region 7. P2 is used to denote the position of the sensor 41 in which the sensor rests against the rump of the animal. A position P3 of the sensor 41, in which the sensor 41 determines a short animal, for example, is illustrated using dashed lines.

A spray nozzle 31a is provided under a protective cover 32 in the base region of the exit region 7. The spray nozzle 31a can be positioned in the longitudinal direction of the exit region 7. To this end, the spray nozzle 31a is connected to a flexible line 35. An actuator 44 is provided for the purpose of moving the spray nozzle 31a. The spray nozzle 31a is positioned on the basis of the result of the sensing of the rump of the animal.

The teats of the animal are automatically disinfected in such a manner that the sensor 23, which is preferably a reflected light button, is first of all used to determine the presence of the animal in the exit region 7. The sensor provides the controller 27 with a signal. Said controller sends an activation signal to a changeover valve for the actuating element 43 which interacts with the sensor 41. As a result of activation, the actuating element 42, which is preferably a piston/cylinder unit, is actuated, with the result that the sensor 41 is brought into abutment against the animal. The force of the actuating element is preferably selected in such a manner that no perceptible pressure is exerted by the sensor 41 on the rump of the animal. The position of a rump of an animal can be determined on the basis of the rotation of the shaft through an angle. The rotary encoder sends corresponding signals to a controller 27 which generates an activation signal for the actuator 44 and sends it to the latter. The actuator 44 positions the spray nozzle 31a in the position suitable for disinfecting the teats of the animal.

If a pushbutton 26 which is firmly connected to the carousel platform passes into the range of the sensor 25, the latter sends a signal to the controller 27 and, preferably with a time delay, to the controller 17. The controller sends an activation signal to the disinfectant delivery device and sends an activation signal to the valve 30a with a time delay. When the valve 30a opens, the disinfectant passes to the teats of the animal in the exit region 7 via the spray nozzle 23a. The period of time during which the valve 30a is open and the delivery device 27 is activated can preferably be adjusted.

After the teats of an animal have been disinfected, the controller 17 outputs an activation signal to a changeover valve 16 for the actuating element and to the changeover valve 23 for the actuating element 42. This opens the apparatus, with the result that the animal leaves the exit region and the sensor 41 changes to the position P1. The sensor 41 may be used, if appropriate, as a driving aid depending on the design of the sensor 41. The sensor 41 is advantageously in the form of a rod or large turnip and is mounted such that it can be rotated about an essentially horizontal axis.

FIGS. 4 and 5 illustrate yet another exemplary embodiment for automatically disinfecting the teats of an animal. The region 7 is bounded by a lattice construction having essentially horizontal and vertical rails. The rails 51a, 51b, 51c; 52a, 52b, 52c are connected to one another and to the base of the exit region 7 by means of fastening elements 62. The exit region 7 has a spray nozzle 31a which is connected to a storage container 63 by means of a line 35, 34. A valve 30a and a delivery device 37 are provided in the line. A protective cover 32 is provided for the purpose of protecting the spray nozzle from the actions of an animal.

In the embodiment illustrated, the blocking apparatus 47 can be moved in the longitudinal direction of the exit region 7. To this end, the blocking apparatus 47 is connected to plates 54a and 54b by means of fastening elements 63a to 63d. Rollers 55a, 55b, 55c and 55d are connected to the plates 54a, 54b which are arranged at a distance from one another. The rollers are mounted using bearings 56a, 56b, 56c and 56d. The rollers slide on the rails 52a and 52c, as can be seen from the illustration shown in FIGS. 4 and 5.

A servomotor 49 which drives a shaft, on which two gearwheels 58a, 58b are provided, is provided for the purpose of setting the position of the blocking apparatus. The gearwheels 58a, 58b can engage in a corresponding toothed rack 48.

It is not absolutely necessary for the blocking apparatus to be moved using a toothed drive. This may also be effected, for example, using a friction-type drive. The apparatus preferably has a locking device in which the position of the blocking apparatus 47 can be locked.

As a result of the fact that the locking apparatus can be moved, the space available inside the exit region 7 is adapted on an animal-individual basis. To this end, provision is preferably made of a herd management system containing animal data and relevant data for controlling processes. This means that the milking system provides information regarding the milking stall in which a relevant animal is situated and also regarding the animal which will leave the milking carousel. If appropriate, identification means which are used to determine the data on the animal may be provided.

If an animal leaves the carousel platform, a process terminal 50 is provided with the requisite data, said process terminal in turn sending an activation signal to the servomotor 49. Irrespective of whether the animal at the carousel platform exit is a long animal or a short animal, the servomotor 49 brings the blocking apparatus 47 to a position corresponding to the length of the animal. This always ensures that the rump of the animal is in a position in which the teats of the animal are above the spraying region of the spray nozzle 31a. If the blocking apparatus has reached its desired position, an activation signal is sent to the comptroller of the disinfecting device. This signal is preferably first of all only stored. If the pushbutton 26 which is firmly connected to the carousel platform 1 passes into the range of the sensor 25, the latter likewise sends a signal to the controller of the disinfecting apparatus.

If the sensor 23 has provided a signal indicating that an animal is in the carousel exit region, the controller 27 is used to send an activation signal to the disinfectant delivery device 37 and to send an activation signal to the valve 30a, preferably with a time delay. The valve 30a opens and disinfectant passes to the spray nozzle 31a and thus to the teats of the animal in the exit region 7. In particular, the duration of the disinfecting operation can be adjusted by means of corresponding control means.

When it is determined, for example, that an animal is injured or ill, an operator in the work pit 45 can use a manual controller to direct the animal into a treatment area using a selection apparatus 59.

The apparatus according to the invention has yet further numerous advantages.

### LIST OF REFERENCE SYMBOLS

| | |
|---|---|
| 1 | Carousel platform |
| 2 | Frameworks |
| 3 | Separating element |
| 4 | Breast rail |
| 5 | Holder |
| 6 | Entry region |
| 7 | Exit region |
| 8 | Separating wall |
| 9 | Side wall |
| 10 | Side wall |
| 11 | Carousel outer wall |
| 12 | Blocking apparatus |
| 13 | Door leaf |
| 14 | Axis |
| 15 | Actuating unit |
| 16 | Changeover valve |
| 17 | Controller |
| 18 | Element |
| 19 | Axis |
| 20 | Safety limit switch |
| 21 | Sensor |
| 22 | Reflected beam |
| 23 | Sensor |
| 24 | Reflected beam |
| 25 | Sensor unit |
| 26 | Pushbutton |
| 27 | Controller |
| 28a, 28b, 28c, 28d | Sensor |
| 29a, 29b, 29c, 29d | Reflected beam |
| 30a, 30b, 30c, 30d | Valve |
| 31a, 31b, 31c, 31d | Spray nozzle |
| 32 | Protective cover |
| 33 | Line connecting piece |
| 34 | Line |
| 35 | Line |
| 36 | Storage container |
| 37 | Delivery device |
| 38a, 38b, 38c | Animal |
| 39 | Animal |
| 40 | Rotary encoder |
| 41 | Sensor |
| 42 | Actuating element |
| 43 | changeover valve |
| 44 | Actuator |
| 45 | Work pit |
| 46 | Operating opening |
| 47 | Blocking apparatus |
| 48 | Toothed rack |
| 49 | Servomotor |
| 50 | Process terminal |
| 51a, 51b, 51c | Rail bend |
| 52a, 52b, 52c | Rail for guide framework |
| 53a, 53b, 53c | Fastening element for guide |
| | framework |
| 54a, 54b | Plate/frame |
| 55a, 55b, 55c, 55d | Guide roller |
| 56a, 56b, 56c, 56d | Bearing for guide roller |
| 57 | Shaft |
| 58a, 58b | Toothed disk |
| 59 | Selection apparatus |
| 60 | Controller |
| 61 | Protective framework |
| 62 | Fastening element |
| 63a, 63b | Fastening element |
| 64, 65, 66, | Milking stall |
| 67 . . . 94, 95, 96, | |
| 97 | |
| X1 | Measurement from the carousel outer |
| | diameter to the blocking apparatus |
| X2 | Measurement from the “animal |
| | position” sensor 28a to spray |
| | nozzle (31a) |
| Y1 | Direction of stall |
| Y2 | Direction of treatment area |
| D1 | Direction of rotation of milking |
| | carousel |
| D2 | Pivoting direction of safety |
| | apparatus |
| D3 | Center of rotation for rotary |
| | encoder or sensor |
| P1 | “Up” sensor position |
| P2 | “Long cow” sensor position |
| P3 | “Short cow” sensor position |

1. A method for carrying out at least one procedure on an animal, said method comprising the steps of
a) successively leading a plurality of animals led to a facility;
b) transferring at least one animal to an exit region of the facility;
c) holding the at least one animal in the exit region until a subsequent animal enters the vicinity of the exit region; and
d) opening the exit region and repeating step b) for the subsequent animal,
wherein the at least one procedure is carried out on at least one animal in the facility and/or in the exit region.

2. The method as claimed in claim 1, further comprising the step of determining whether or not the exit region is occupied.

3. The method as claimed in claim 1, further comprising the step of determining whether an animal has left the exit region.

4. The method as claimed in claim 1, wherein the exit region includes a blocking apparatus which is actuated on the basis of the position of a subsequent animal.

5. The method as claimed in claim 2, wherein the step of determining the occupancy of the exit region comprises using at least one sensor which generates a signal for a controller of the blocking apparatus.

6. The method as claimed in claim 4, further comprising the step of using at least one other sensor to determine whether a subsequent animal has reached a predetermined position, and opening the blocking apparatus only when the at least one other sensor has established that the subsequent animal has reached the predetermined position.

7. The method as claimed in claim 2, further comprising the step of closing the exit region with a blocking apparatus when a sensor generates a signal indicating that the animal has vacated the exit region.

8. The method as claimed in claim 1, wherein a beginning of the procedure in the exit region depends on a position of the subsequent animal.

9. The method as claimed in claim 1, further comprising the step of determining a position of at least one body part, of an animal in the exit region.

10. The method as claimed in claim 1, further comprising the step of adjusting a length of the exit region.

11. The method as claimed in claim 10, wherein the step of adjusting the length comprises moving a blocking apparatus in a longitudinal direction of the exit region.

12. The method as claimed in claim 10, wherein the step of adjusting the length of the exit region comprises adjusting on an animal-individual basis.

13. The method as claimed in claim 1, wherein the at least one procedure in the exit region comprises at least one disinfecting step.

14. The method as claimed in claim 13, wherein the at least one disinfectant step comprises spraying at least one disinfectant onto the teats of the animal using at least one nozzle.

15. The method as claimed in claim 14, wherein the at least one nozzle can be moved in a longitudinal direction of the exit region.

16. The method as claimed in claim 1, wherein the facility further comprises at least one platform which can be moved relative to the exit region comprising a plurality of milking stalls, wherein at least one animal can be milked in at least one of the milking stalls.

17. The method as claimed in claim 16, wherein the at least one platform can be rotated.

18. An apparatus for carrying out at least one procedure on an animal, said apparatus comprising at least one milking stall and an exit region, wherein the exit region comprises a blocking apparatus which opens the exit region when a subsequent animal enters a vicinity of the exit region.

19. The apparatus as claimed in claim 18, further comprising at least one sensor provides capable of providing a controller of the blocking apparatus with a signal when the exit region is occupied.

20. The apparatus as claimed in claim 18, further comprising at least one other sensor capable of determining whether a subsequent animal has reached a predetermined position so that the blocking apparatus opens only when the at least one other sensor has established that the subsequent animal has reached the predetermined position.

21. The apparatus as claimed in claim 18, further comprising at least one other sensor for detecting a position of at least one body part, of an animal in the exit region.

22. The apparatus as claimed in claim 18, wherein a length of the exit region can be adjusted.

23. The apparatus as claimed in claim 22, wherein the blocking apparatus can be moved in a longitudinal direction of the exit region.

24. The apparatus as claimed in claim 22, further comprising a controller which comprises a data memory containing animal-individual data, wherein the length of the exit region is adjustable on an animal-individual basis.

25. The apparatus as claimed in claim 18, further comprising at least one disinfecting device in the exit region.

26. The apparatus as claimed in claim 25, wherein the at least one disinfecting device comprises at least one nozzle.

27. The apparatus as claimed in claim 26, wherein the at least one nozzle can be moved in the longitudinal direction of the exit region.

28. The apparatus as claimed in claim 18, further comprising at least one platform which can be moved relative to the exit region and comprising a plurality of milking stalls.

29. The apparatus as claimed in claim 28, wherein the at least one platform can be rotated.
